(19) United States
(12) Patent Application Publication
(10) Pub. No.: US 2026/0173068 A1
(43) Pub. Date: Jun. 18, 2026

(54) METHOD, APPARATUS, AND SYSTEM FOR REDUCED BLIND DETECTION DURING INITIAL ACCESS

(71) Applicant: Huawei Technologies Co., Ltd., Shenzhen (CN)

(72) Inventors: Liqing Zhang, Ottawa (CA); Jianglei Ma, Ottawa (CA); Hao Tang, Ottawa (CA)

(21) Appl. No.: 19/535,799

(22) Filed: Feb. 10, 2026

Related U.S. Application Data
(63) Continuation of application No. PCT/CN2023/139015, filed on Dec. 15, 2023.
(60) Provisional application No. 63/519,055, filed on Aug. 11, 2023.

(51) Int. Cl. H04W 72/12; H04W 72/20; H04W 72/543

(52) U.S. Cl. CPC H04W 72/12; H04W 72/20; H04W 72/543

(57) ABSTRACT

Aspects of the present disclosure provide methods, apparatuses, devices and systems for detecting or identifying a control channel used to transmit scheduling information during initial access, in order to save resources, avoid unnecessary redundant signals, and reduce power consumption. An apparatus may transmit, to a device, information indicative of a group of resources for receiving signaling from the device. The device may transmit to the apparatus, over a control channel, scheduling information for a data transmission between the apparatus and the device. The control channel is one of one or more control channel candidates of which the group of resources is indicative. The apparatus may perform detection on the one or more control channel candidates to identify the control channel.

### CROSS-REFERENCE TO RELATED APPLICATIONS

This application is a continuation of International Application No. PCT/CN2023/139015 filed on Dec. 15, 2023, which claims priority to and the benefit of U.S. Provisional Application No. 63/519,055 filed in the U.S. Patent and Trademark Office on Aug. 11, 2023, all of which are incorporated by reference herein in their entirety.

### TECHNICAL FIELD

The present disclosure relates generally to wireless communications, and in particular to methods, apparatuses, devices and systems for detecting or identifying a control channel used to transmit scheduling information in a wireless network that may reduce blind detection.

### BACKGROUND

One type of control signaling message in a wireless network is scheduling messages. Scheduling messages may include downlink (DL) control information (DCI) for (dynamically) scheduling or granting DL and/or uplink (UL) transmission time-frequency resources as well as other transmission related parameters in a DL control channel, such as a PDCCH (physical DL control channel). A PDCCH may be transmitted in a time-frequency resource region to carry a scheduling message. The time-frequency resource region used for a PDCCH may be pre-defined (e.g., using fixed or tabulated rules), determined based on system information (SI), broadcast, cell-group configured or UE-specific configured, for example, via RRC (radio resource control).

The time-frequency resource region may also be referred to as a (PDCCH) search space. A search space is the area in the downlink resource grid where one or more CCCs (i.e., PDCCH candidates) may be configured, where each PDCCH has a configured time-frequency location, and at least one of the PDCCHs may be used to carry out a control signaling at each PDCCH occasion (that a UE needs to monitor). In order for a UE to decode a PDCCH (or more generally a DCI), the UE has to figure out the exact value for location (e.g. one or more control channel element (CCE) index) of the PDCCH. Which PDCCH carries a signaling message at a PDCCH occasion is not known by the UE beforehand and, in most cases, a PDCCH that carries a signaling message may change dynamically. The UE may have to try to determine the PDCCH by detecting signals on one or more locations (i.e., the configured time-frequency resource) of the PDCCH over a predefined region that includes one or more PDCCH candidates based on trial and error (i.e., by trying different PDCCH candidates until the detection is successful). This method of decoding may be called blind detection.

The PDCCH may be one of a set of PDCCH candidates defined over the time-frequency resource region. The set of PDCCH candidates is referred to as a control resource set (CORESET). There are often more than one PDCCH candidate in a CORESET for one UE (user equipment) or for a group of UEs. Each PDDCH candidate may be configured to have different encoding or redundant transmission versions to support the UE or group of UEs as the UE or group of UEs may be located in different geographical locations within a cell due to UE mobility and changing wireless channel environment. As a result, the UE or group of UEs may need to monitor scheduling messages received from the network and detect an incoming PDCCH through blind detection. A UE specific RNTI (Radio Network Temporary Identifier) or a group RNTI (e.g., semi-statically configured before communication) may be used to scramble the CRC (Cyclic Redundancy Check) of the incoming PDCCH payload (e.g., DCI).

In NR (new radio) networks, including 5G networks, for example, a CORESET may consist of 1, 2, or 3 symbols and one or more RBs (resource blocks) in a frequency domain. For example, there may be 24, 48 or 96 RBs for initial access procedures and up to 275 RBs for UE specific transmissions.

PDCCHs fall into three categories according to their application scenarios and functions: common PDCCHs, group common PDCCHs and UE-specific PDCCHs. A common PDCCH is used for transmitting common messages (such as system information such as remaining minimum system information (RMSI) or other system information (OSI)) and scheduling data (e.g., 4-step RACH (random access channel) Msg2/Msg4) before an RRC connection to the UE is established. A group common PDCCH is used for scheduling a group of UEs, e.g., scheduling the slot format indicator (SFI) for a UE group. A UE-specific PDCCH is used for scheduling UE-specific data and power control information.

As a PDCCH may carry scheduling and control messages, which are critical communication messages in DL and/or UL transmission, it should be reliable enough to guarantee the reception at the receiving end (e.g., the UE side). An encoding or redundant transmission version may include schemes referred to as aggregation levels (AL). For example, in NR networks, an aggregation level of a PDCCH candidate may be any one of AL1 (aggregation level 1), AL2, AL4, AL8 and AL16, where a PDCCH candidate with AL1 may take one control channel element (CCE) (that consists of six physical resource blocks (PRBs)) as a time-frequency resource or the PDCCH channel resource. A PDCCH candidate with ALx (x>=1) may take x CCEs as a time-frequency resource or the PDCCH channel resource that is used to transmit a DCI. ALx>=1 may refer to an AL that is equal to or greater than the aggregation level 1. “x” is an integer that may indicate the aggregation level or the number of CCEs allocated for a PDCCH. In other words, one CCE may be allocated as a time-frequency resource for a PDCCH with AL1, two CCEs may be allocated as a time-frequency resource for a PDCCH with AL2, four CCEs may be allocated as a time-frequency resource for a PDCCH with AL4, eight CCEs may be allocated as a time-frequency resource for a PDCCH with AL8, and sixteen CCEs may be allocated as a time-frequency resource for a PDCCH with AL16. A common PDCCH or group common PDCCH may be pre-defined, broadcast, cell-group configured or UE-specific configured with, for example, AL4, AL8 or AL16 while a UE-specific PDCCH may be configured with, for example, AL1, AL2, AL4, AL8 or AL16. A PDCCH with a higher aggregation level may use more resources to perform more strong channel encoding and hence, may be more reliable in DCI transmission. For example, AL16 may use 16 times the amount of the resources used by AL1, so a PDCCH with AL16 may have much more robust channel encoding resulting in more reliable transmission that a PDCCH with AL1.

One or more PDCCH candidates may be configured for each AL. If, for example, up to 8 PDCCH candidates are configured for each AL, there may be up to 40 PDCCH candidates that need to be monitored and blindly detected by the UE(s) for an incoming PDCCH upon transmission of each DCI. Blindly detecting an incoming PDCCH for each scheduling occasion may consume a lot of time and resources. Furthermore, the network may transmit unnecessary redundant signals, resulting in more power consumption, as a conservative way to achieve a reliable transmission of crucial control message if the network does not know the channel conditions or an accurate location of the UE.

As a result, there is a need to find ways of reducing the need for blind detection on PDCCH and of saving resources and power.

### SUMMARY

Aspects of the present disclosure provide methods, apparatuses, devices and systems to overcome the shortcomings described above, as well as specific methods, apparatuses, devices, and systems for detecting or identifying a control channel used to transmit scheduling information in a wireless network.

In some embodiments, the information indicative of the group of resources includes at least one of: a preamble used to establish connection between the apparatus and the device; information indicative of quality of a signal used for communication between the apparatus and the device; or an indication of the group of resources.

In some embodiments, the information indicative of the group of resources is included in at least one message from the apparatus to the device during an initial access procedure.

In some embodiments, the information indicative of the group of resources includes a preamble included in a preamble transmission during an initial access procedure and the preamble is from a preamble group comprising one or more preambles associated with at least one of: the quality of the signal used for communication between the apparatus and the device, or the group of resources. The preamble group may be all or a subset of preambles to be used for establishing the connection between the apparatus and the device.

In some embodiments, when the information indicative of the group of resources is included in a scheduled data transmission message during an initial access procedure, the information indicative of the group of resources includes at least one of: the information indicative of the quality of the signal used for communication between the apparatus and the device; or the indication of the group of resources.

In some embodiments, the method further includes receiving, from the device, configuration information used for determining the information indicative of the group of resources, the configuration information including at least one of: information indicative of a first association that is an association between the group of resources and quality of a signal used for communication between the apparatus and the device, information indicative of a second association that is an association between a preamble group and quality of the signal used for communication between the apparatus and the device, or information indicative of a third association that is an association between the group of resources and the preamble group. The preamble group may be all or a subset of preambles to be used for establishing the connection between the apparatus and the device.

In some embodiments, the configuration information is received via system information or a radio resource control (RRC) signaling.

In some embodiments, when configuration information used for determining the information indicative of the group of resources is predetermined, the configuration information includes at least one of: information indicative of a first association that is an association between the group of resources and quality of a signal used for communication between the apparatus and the device, information indicative of a second association that is an association between a preamble group and the quality of the signal used for communication between the apparatus and the device, or information indicative of a third association that is an association between the group of resources and the preamble group. The preamble group may be all or a subset of preambles to be used for establishing the connection between the apparatus and the device.

In some embodiments, at least one of the first association, the second association, or the third association is a one-to-one, one-to-many, many-to-one, or many-to-many association.

In some embodiments, the information indicative of the quality of the signal used for communication between the apparatus and the device includes a channel state information (CSI) report.

In some embodiments, the CSI report includes at least one of: reference signal received power (RSRP); reference signal received quality (RSRQ); signal-to-interference plus noise ratio (SINR); synchronization signal block (SSB) RSRP; SSB RSRQ; or SSB SINR.

In some embodiments, the quality of the signal used for communication between the apparatus and the device is determined based on a channel measurement on a downlink (DL) reference signal (DLRS).

In some embodiments, the method further includes receiving, from the device, data in a transmission resource associated with the scheduling information received over the control channel wherein the data includes at least one of a random access response message and a contention resolution message.

In some embodiments, the scheduling information includes downlink control information (DCI).

In some embodiments, the control channel is a physical downlink control channel (PDCCH).

In some embodiments, the group of resources include an aggregation level group for receiving signaling from the device.

In some embodiments, the aggregation level group comprises one or more aggregation levels.

In some embodiments, each of the one or more aggregation levels comprises one or more control channel elements (CCEs).

According to an aspect of the disclosure there is provided an apparatus comprising means to perform any of the methods mentioned in this disclosure. In details, the apparatus including a processor coupled with a computer-readable medium. The computer-readable medium is configured to store computer executable instructions and the processor is configured to execute the computer executable instructions to cause the apparatus to perform a method consistent with the embodiments described above and herein. A non-limiting example of the apparatus is a user equipment (UE). In some embodiments, the apparatus comprises a chip, e.g., an integrated circuit (IC) chip. In some embodiments, the apparatus does not execute instructions by a processor to perform the methods, e.g., the apparatus may comprise circuitry such as a field-programmable gate array (FPGA), a graphical processing unit (GPU), or an application-specific integrated circuit (ASIC), that performs the methods. More generally, the apparatus may comprise modules or units or means to perform the methods.

According to an aspect of the present disclosure, there is provided an apparatus in a wireless network. The apparatus includes a transmitting unit configured to transmit, to a device, information indicative of a group of resources for receiving signaling from the device, the group of resources indicative of one or more control channel candidates, wherein at least one of the one or more control channel candidates is to be used by the device to transmit scheduling information for a data transmission between the apparatus and the device in the wireless network. The apparatus further includes a receiving unit configured to perform detection on the one or more control channel candidates to identify a control channel used by the device to transmit the scheduling information.

According to an aspect of the disclosure there is provided a method for use by a device in a wireless network including receiving, from an apparatus, information indicative of a group of resources for transmitting signaling to the apparatus, the group of resources indicative of one or more control channel candidates. The method may further include transmitting, to the apparatus over a control channel, scheduling information for a data transmission between the apparatus and the device in the wireless network, wherein the control channel is one of the one or more control channel candidates.

In some embodiments, the information indicative of the group of resources includes at least one of: a preamble used to establish connection between the apparatus and the device; information indicative of quality of a signal used for communication between the apparatus and the device; or an indication of the group of resources.

In some embodiments, the information indicative of the group of resources is included in at least one message from the apparatus to the device during an initial access.

In some embodiments, the information indicative of the group of resources includes a preamble included in the at least one message from the apparatus to the device during the initial access procedure.

In some embodiments, the preamble is associated with at least one of: the quality of the signal used for communication between the apparatus and the device, or the group of resources.

In some embodiments, when the information indicative of the group of resources is included in a scheduled data transmission message during an initial access procedure, the information indicative of the group of resources includes at least one of: the information indicative of the quality of the signal used for communication between the apparatus and the device; or the indication of the group of resources.

In some embodiments, the method further includes transmitting, to the apparatus, configuration information used for determining the information indicative of the group of resources, the configuration information including at least one of: information indicative of a first association that is an association between the group of resources and quality of a signal used for communication between the apparatus and the device, information indicative of a second association that is an association between a preamble group and quality of the signal used for communication between the apparatus and the device, or information indicative of a third association that is an association between the group of resources and the preamble group. The preamble group may be all or a subset of preambles to be used for establishing the connection between the apparatus and the device.

In some embodiments, the configuration information is transmitted via system information or a radio resource control (RRC) signaling.

In some embodiments, when configuration information used for determining the information indicative of the group of resources is predetermined, the configuration information includes at least one of: information indicative of a first association that is an association between the group of resources and quality of a signal used for communication between the apparatus and the device, information indicative of a second association that is an association between a preamble group and the quality of the signal used for communication between the apparatus and the device, or information indicative of a third association that is an association between the group of resources and the preamble group. The preamble group may be all or a subset of preambles to be used for establishing the connection between the apparatus and the device.

In some embodiments, at least one of the first association, the second association, or the third association is a one-to-one, one-to-many, many-to-one, or many-to-many association.

In some embodiments, the information indicative of the quality of the signal used for communication between the apparatus and the device includes a channel state information (CSI) report.

In some embodiments, the CSI report includes at least one of: reference signal received power (RSRP); reference signal received quality (RSRQ); signal-to-interference plus noise ratio (SINR); synchronization signal block (SSB) RSRP; SSB RSRQ; or SSB SINR.

In some embodiments, the quality of the signal used for communication between the apparatus and the device is determined based on a channel measurement on a downlink (DL) reference signal (DLRS).

In some embodiments, the method further includes transmitting, to the apparatus, data in a transmission resource associated with the scheduling information transmitted over the control channel wherein the data includes at least one of a random access response message and a contention resolution message.

In some embodiments, the scheduling information includes downlink control information (DCI).

In some embodiments, the control channel is a physical downlink control channel (PDCCH).

In some embodiments, the group of resources include an aggregation level group for transmitting signaling to the apparatus.

In some embodiments, the aggregation level group comprises one or more aggregation levels.

In some embodiments, each of the one or more aggregation levels comprises one or more control channel elements (CCEs).

According to an aspect of the disclosure there is provided a device comprising means to perform any of the methods mentioned in this disclosure. In details, the device includes a processor coupled with a computer-readable medium. The computer-readable medium has stored thereon computer executable instructions that when executed cause the device to perform a method consistent with the embodiment described above. Non-limiting examples of the device are to a base station (BS). In some embodiments, the device comprises a chip, e.g., an IC chip. In some embodiments, the device does not execute instructions by a processor to perform the methods, e.g., the device may comprise circuitry such as an FPGA, a GPU, or an ASIC, that performs the methods. More generally, the device may comprise modules or units or means to perform the methods.

According to an aspect of the present disclosure, there is provided a device in a wireless network. The device includes a receiving unit configured to receive, from an apparatus, information indicative of a group of resources for transmitting signaling to the apparatus, the group of resources indicative of one or more control channel candidates. The device further includes a transmitting unit configured to transmit, to the apparatus, over a control channel, scheduling information for a data transmission between the apparatus and the device in the wireless network, wherein the control channel is one of the one or more control channel candidates.

According to an aspect of the disclosure, there is provided a computer-readable storage medium. The computer-readable storage medium stores computer executable instructions that, when executed by a processor of an apparatus, cause the apparatus to perform any of the methods as described above. The computer-readable storage medium may be non-transitory.

In some aspects of the present disclosure, there is provided an apparatus/chipset system comprising means (e.g., at least one processor) to implement any of the methods implemented by (or at) a UE of the present disclosure. The apparatus/chipset system may be the UE (that is, a terminal device) or a module/component in the UE. In details, the at least one processor may execute instructions stored in a computer-readable medium to implement any of the methods.

In some aspects of the present disclosure, there is provided an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method.

In some aspects of the present disclosure, there is provided a device configured to perform the method according to any of the methods mentioned in this disclosure.

In some aspects of the present disclosure, there is provided a processor configured to execute instructions to cause a device to perform any of the methods mentioned in this disclosure.

In some aspects of the present disclosure, there is provided an integrated circuit configured to perform the method according to any of the methods mentioned in this disclosure.

In some aspects of the present disclosure, there is provided a system comprising at least one of an apparatus in (or at) a UE of the present disclosure, or an apparatus in (or at) a network device of the present disclosure.

In some aspects of the present disclosure, there is provided a method performed by a system comprising at least one of an apparatus in (or at) a UE of the present disclosure, or an apparatus in (or at) a network device of the present disclosure.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 illustrates an example arrangement of control channel candidates at different aggregation levels (ALs) where the time frequency resources carrying the control channel candidates may be overlapped, in accordance with embodiments of the present disclosure.

FIG. 6 illustrates an example mapping between a channel measurement and a group of AL(s) for physical downlink control channel (PDCCH) transmission, in accordance with embodiments of the present disclosure.

FIG. 7 illustrates an example mapping between a preamble group (or a preamble subset) and a channel measurement range, in accordance with embodiments of the present disclosure.

FIG. 8 illustrates an example mapping between a preamble group (or a preamble subset) and a group of AL(s) for PDCCH transmission, in accordance with embodiments of the present disclosure.

FIG. 9 illustrates an example of a signal flow diagram for a 4-step random access channel (RACH) procedure with a channel state information (CSI) report or an indication of AL(s), in accordance with embodiments of the present disclosure.

FIG. 10 illustrates an example of a signal flow diagram for a 2-step RACH procedure with a CSI report or an indication of AL(s), in accordance with embodiments of the present disclosure.

FIG. 11 is a signal flow diagram illustrating an example method for detecting or identifying a control channel used to transmit scheduling information in a wireless network, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure provide methods, apparatuses, devices and systems to overcome the shortcomings described above, as well as specific methods, apparatuses, devices, and systems for, for example, detecting or identifying a control channel (e.g., physical downlink control channel (PDCCH)) that may be used to transmit scheduling information during initial access in a wireless network. The methods, apparatuses, devices, and systems proposed in the present disclosure may save resources, avoid unnecessary redundant signals, reduce a number of blind detections on the control channel, and/or reduce power consumption. According to some embodiments of the present disclosure, an apparatus (e.g., user equipment (UE)) may transmit, to a device (e.g., base station), information indicative of a group of resources for receiving signaling from the device. The group of resources may be indicative of one or more control channel candidates that may be used for transmission of scheduling information. The group of resources may include, for example, an aggregation level (AL) group for receiving signaling from the device. The AL group may comprise one or more ALs. The device may transmit, to the apparatus over a control channel, scheduling information for the data transmission between the apparatus and the device. The control channel used by the device for transmission of the scheduling information may be one of the control channel candidates indicated by the group of resources (e.g., AL group). The apparatus may perform detection on the control channel candidates to identify the control channel that is used by the device to transmit the scheduling information.

This application may be applied to 6G or future generation communications system. An exemplary 6G system is illustrated below.

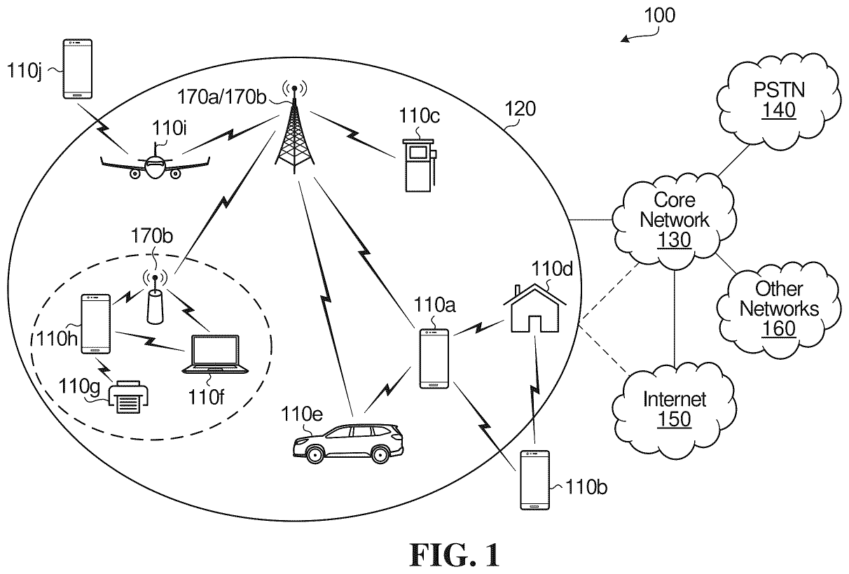

FIG. 1 illustrates an example communication system in which embodiments of the present disclosure may occur.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

In this application, a base station is an example of network node 170, and user equipment (UE) is an example of ED 110.

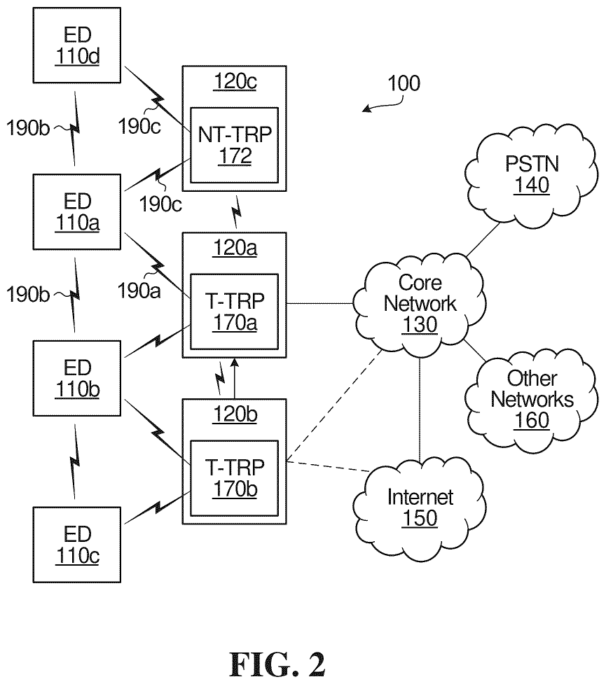

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c may enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

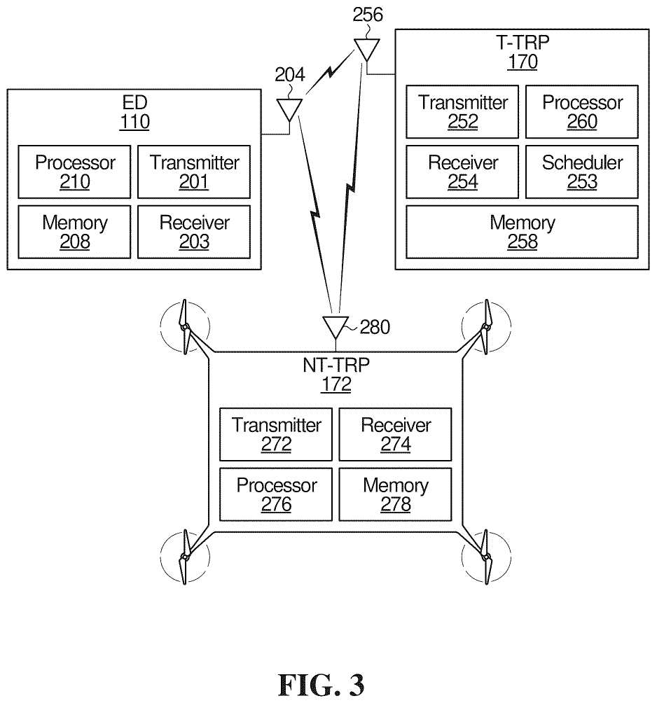

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 may be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or implementations described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the implementation, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some implementations, the processor 276 implements the transmit beamforming and/or receive beamforming based on the indication of beam direction, e.g. beam angle information (BAI), received from T-TRP 170. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In some implementations, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some implementations, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some implementations, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some implementations, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some implementations, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or implementations described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some implementations, the processor 276 implements the transmit beamforming and/or receive beamforming based on beam direction information (e.g. BAI) received from T-TRP 170. In some implementations, the processor 276 may generate signaling, e.g. to configure one or more parameters of the ED 110. In some implementations, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some implementations, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

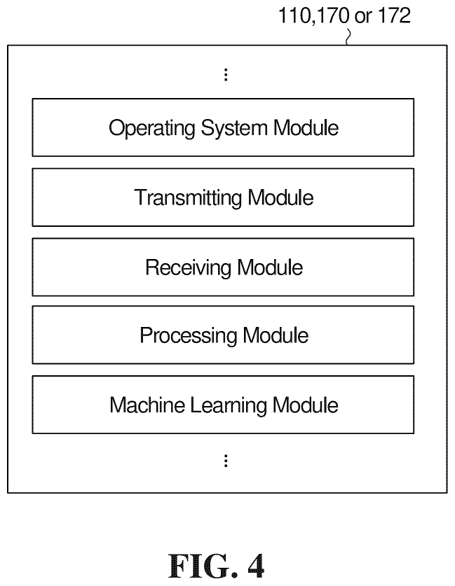

One or more steps of the implementation methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some implementations, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, may be configured. In some implementations, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device may both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case, the frame length is set at 10 ms, and consists of ten subframes of ims each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Implementations of flexible frame structures include different parameters that may be configurable, e.g. frame length, subframe length, symbol block length, etc. A non-exhaustive list of possible configurable parameters in some implementations of a flexible frame structure include the followings.
(1) Frame: The frame length need not be limited to 10 ms, and the frame length may be configurable and change over time. In some implementations, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some implementations, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one implementation, the slot configuration is common to all UEs or a group of UEs. For this case, the slot configuration information may be transmitted to UEs in a broadcast channel or common control channel(s). In other implementations, the slot configuration may be UE specific, in which case the slot configuration information may be transmitted in a UE-specific control channel. In some implementations, the slot configuration signaling may be transmitted together with frame configuration signaling and/or subframe configuration signaling. In other implementations, the slot configuration may be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures may be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some implementations the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some implementations, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some implementations, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some implementations, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other implementations, a BWP may have one or more carriers, e.g. a BWP may have a bandwidth of 40 MHz and consists of two adjacent contiguous carriers, where each carrier has a bandwidth of 20 MHz. In some implementations, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some implementations, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage □/2 of the total mean transmitted power, for example, the value of □/2 is taken as 0.5%.

The carrier, the BWP, or the occupied bandwidth may be signaled by a network device (e.g. base station) dynamically, e.g. in physical layer control signaling such as DCI (downlink control information), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

While the phrase “initial access” is used above and subsequently below, it should be understood that “initial access” may be replaced with “contention-based random access” or “contention-free random access”.

In the present disclosure, terms “apparatus” and “device” are simply used to more easily distinguish between the entities. A non-limiting example of the apparatus is a user equipment (UE), or any other terminal devices or elements therein. A non-limiting example of the device is a base station, or any other network side devices or components therein.

A legacy network, such as an NR network, may have a common search space (CSS) with AL4, AL8 and AL16, where each AL may have up to 8 PDCCH candidates that may be configured. Therefore, there may be up to a total of 24 PDCCH candidates for the three ALs configured with a CSS. Such a network may also have a UE specific search space (USS) with AL1, AL2, AL4, AL8 and AL16, where each AL may have up to 8 PDCCH candidates that may be configured. Therefore, there may be a total of up to 40 PDCCH candidates for the five ALs configured with a USS. Among multiple PDCCH candidates configured with CSS or USS, only one PDCCH candidate may be used for each DCI transmission.

CSSs and USSs are search spaces on PDCCH candidates for cell based (e.g., a group of UEs in the cell) and UE specific configurations respectively. The search space is defined, including one CORESET as one unit area in defining multiple PDCCH candidates, by how long (e.g., how many slots or frames) the PDCCH detection will last and by how many PDCCHs there are per slot and which symbol(s) in a slot are used for PDCCH transmissions, etc.

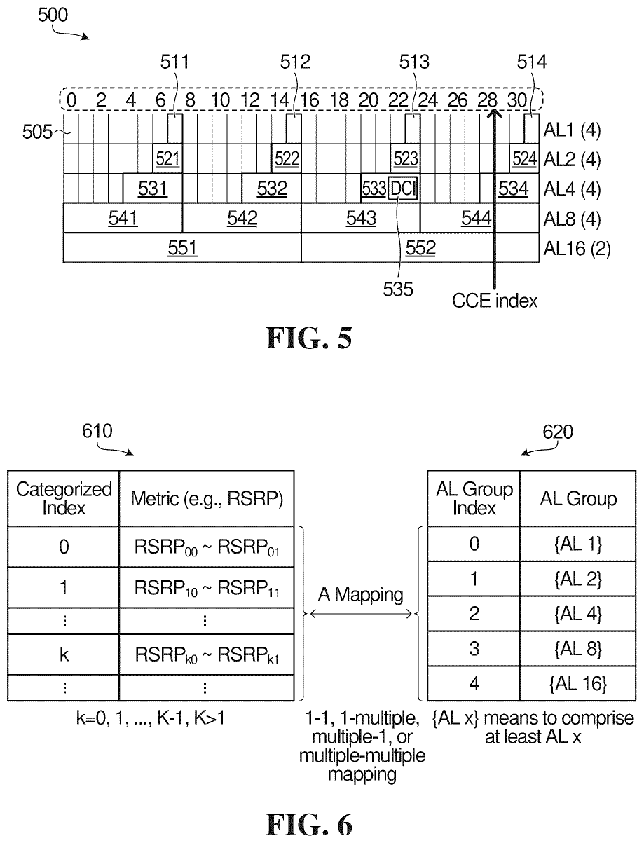

For example, for a UE configuration with a CORESET having a frequency resource of 96 physical resource blocks, a time resource of 2 symbols and an aggregation configuration with AL1(4)/AL2(4)/AL4(4)/AL8(4)/AL16(2) (where ALx (y) means aggregation level x with y PDCCH candidates) there would be a total of 18 PDCCH candidates. From a UE reception perspective, the UE has to perform blind detection for a (dynamic) scheduling (i.e., DCI signaling) occasion or PDCCH monitoring occasion amongst 18 PDCCH candidates, though only one PDCCH may be used for the actual transmission that carries the scheduling (i.e., DCI signaling), as shown in FIG. 5.

FIG. 5 illustrates an example arrangement of control channel candidates at different ALs, where the time-frequency resources carrying the control channel candidates may be overlapped. Specifically, FIG. 5 illustrates an example of PDCCH candidates with 5 aggregation levels, where each PDCCH candidate may be carried in a time-frequency resource represented by one or more control channel elements (CCEs) (each CCE may be identified by a pre-defined or configured CCE index), and at least one PDCCH candidate may be used as a (DL) control channel to carry a DCI or scheduling information in a scheduling occasion. However, it is noted that the example shown in FIG. 5 may be similarly applicable for other type of control channels. As noted above, in FIG. 5, ALx (y) means aggregation level “x” with “y” control channel candidates (e.g., PDCCH candidates) that are configured.

Referring to FIG. 5, a PDCCH region 500 (i.e., time-frequency resources for transmission) is represented by a plurality of CCEs, for example a CCE 505, that may be used to transmit scheduling information from a device (e.g., base station) to an apparatus (e.g., UE). The scheduling information may be DCI or other type of scheduling information. The apparatus receiving the control channels, for example a UE, may search for time-frequency resources of a control channel represented by one or more CCEs that may be used for transmission of the scheduling information over the control channel.

Referring to FIG. 5, the numbers 0, 2, 4, . . . , 30 shown on top of FIG. 5 indicate control channel element (CCE) indices. The CCEs may be formed by dividing the CORESET time-frequency resources or CORESET resource region into non-overlapping resource units, and each CCE may be identified by an (designated, predefined or configured) index. As shown in FIG. 5, there are CCEs with CCE indices from 0 to 31 in the PDCCH region 500. The CCE index indicates the CCE number to present a resource unit at which a control channel (e.g., PDCCH) may be allocated for transmission. e FIG. 5 illustrates multiple PDCCH candidates and multiple (indexed) CCEs. One or more of these (indexed) CCE(s) may be allocated to each of the multiple PDCCH candidates as channel time-frequency resources, and the number of CCEs allocated to each PDCCH channel candidate may be indicative of a respective aggregation level (AL). As a result, the time-frequency resources allocated to the different PDCCH candidates may be (partially) overlapping (on one or more CCEs).

As shown in FIG. 5, there are a total of 18 configured PDCCH candidates with varying aggregation levels. Specifically, there are 4 PDCCH candidates having AL1, 4 PDCCH candidates having AL2, 4 PDCCH candidates having AL4, 4 PDCCH candidates having AL8, and 2 PDCCH candidates having AL16.

The various aggregation levels AL1, AL2, etc., represent different ways that a subset of 32 CCEs may be allocated to PDCCH candidates as transmission resources.

For the set of 32 CCEs, in the case of using AL1, a PDCCH candidate 511, 512, 513, 514 consisting of a single CCE is allocated in each group of 8 CCEs in the total of 32 CCEs in this configuration. In other words, each of the PDCCH candidates 511, 512, 513, and 514 uses a single (indexed) CCE as its time-frequency resource. In FIG. 5, the PDCCH candidate 511 having AL1 may include a CCE with an index 7, the PDCCH candidate 512 having AL1 may include a CCE with an index 15, the PDCCH candidate 513 having AL1 may include a CCE with an index 23, and the PDCCH candidate 514 having AL1 may include a CCE with an index 31.

For the same set of 32 CCEs, in the case of using AL2, a PDCCH candidate 521, 522, 523, 524 consisting of two CCEs is allocated in each group of 8 CCEs in the total of 32 CCEs in this configuration. In other words, each of the PDCCH candidates 521, 522, 523, and 524 uses two (indexed) CCEs as its time-frequency resource. In FIG. 5, the PDCCH candidate 521 having AL2 may include CCEs with indices 6 and 7, the PDCCH candidate 522 having AL2 may include CCEs with indices 14 and 15, the PDCCH candidate 523 having AL2 may include CCEs with indices 22 and 23, and the PDCCH candidate 524 having AL2 may include CCEs with indices 30 and 31.

For the same set of 32 CCEs, in the case of using AL4, a PDCCH candidate 531, 532, 533, 534 consisting of four CCEs is allocated in each group of 8 CCEs in the total of 32 CCEs in this configuration. In other words, each of the PDCCH candidates 531, 532, 533, and 534 uses four (indexed) CCEs as its time-frequency resource. In FIG. 5, the PDCCH candidate 531 having AL4 may include CCEs with indices 4 to 7, the PDCCH candidate 532 having AL4 may include CCEs with indices 12 to 15, the PDCCH candidate 533 having AL4 may include CCEs with indices 20 to 23, and the PDCCH candidate 534 having AL4 may include CCEs with indices 28 to 31.

For the same set of 32 CCEs, in the case of using AL8, a PDCCH candidate 541, 542, 543, 544 consisting of eight CCEs is allocated in each group of 8 CCEs in the total of 32 CCEs in this configuration. In other words, each of the PDCCH candidates 541, 542, 543, and 544 uses eight (indexed) CCEs as its time-frequency resource. In FIG. 5, the PDCCH candidate 541 having AL8 may include CCEs with indices 1 to 7, the PDCCH candidate 542 having AL8 may include CCEs with indices 8 to 15, the PDCCH candidate 543 having AL8 may include CCEs with indices 20 to 23, and the PDCCH candidate 544 having AL8 may include CCEs with indices 24 to 31.

For the same set of 32 CCEs, in the case of using AL16, a PDCCH candidate 551, 552 consisting of 16 CCEs is allocated in two groups of 8 CCEs in the total of 32 CCEs. in this configuration. In other words, each of the PDCCH candidate 551 and 552 uses allocated 16 (indexed) CCEs as its time-frequency resource. In FIG. 5, the PDCCH candidate 551 having AL16 may include CCEs with indices 0 to 15, and the PDCCH candidate 552 having AL16 may include CCEs with indices 16 to 31.

Among multiple PDCCH candidates, at least one PDCCH may be used for transmission of the scheduling information for the apparatus. In FIG. 5, the DCI 535 for scheduling a data transmission between the apparatus and the device may be carried over to the PDCCH candidate 533 occupying CCEs with indices 20 to 24. In other words, the device (e.g., base station) may transmit the DCI 535 to the apparatus (e.g., UE) over the PDCCH 533 including CCEs with indices 20 to 24.

If the apparatus is notified that the DCI is transmitted on a PDCCH candidate using at least an AL4, then the apparatus may be able to monitor (e.g. perform blind detections) PDCCH candidates 531, 532, 533, 534, 541, 542, 543, 544, 551 and 552 as opposed to monitoring all of the possible PDCCH candidates, thereby saving resources and potentially finding the DCI in a more timely manner due to the reduced amount of monitoring involved. Depending on how the UE performs blind detection, the DCI may be found sooner or later. For example, if the UE performs blind detection of all AL4 PDCCH candidates from left to right in FIG. 5, e.g. in the order of 531, 532, 533, 534, then the DCI will be found in a third detection attempt and the UE may not bother to detect PDCCH candidates 534, 541, 542, 543, 544, 551 and 552. However, with a different ordering of PDCCH candidate blind detections, such as starting with AL16, more blind detection attempts may be performed before the DCI is found in AL4 533. However, in either case, not all of the PDCCH candidates are being blind detected, only as many as necessary to find the DCI in AL4, AL8 and A16.

Current networks, such as NR networks, may use blind detections for each DCI reception or each PDCCH monitoring occasion to be performed over all PDCCH candidates that are configured, which may not be necessary in all situations. The power and other resource consumption in current blind detection methods on PDCCH may be too high to be accepted in an energy efficient wireless network, such as a 6G network.

The present disclosure proposes schemes to avoid or reduce the need for (a number of) blind detections on PDCCHs. Such schemes may correspond to methods performed by apparatuses such as UEs. For example, during initial access to a network, the minimum aggregation level is currently 4 (AL4), which means that a UE initially accessing the network has to try to detect PDCCH candidates associated with AL4, AL8 and AL16. This may not be the case when the UE is very close to a serving base station, where for example, PDCCH with AL 1 is sufficient. When the UE is close to the serving base station, the signal from the base station is perceived to be stronger, and as such the DCI does not need to be encoded in a more robustness manner, such as in the longer PDCCH candidates, e.g. AL8 and AL16. Hence, in this particular scenario of UE close to base station, a condition of “at least AL4” used for PDCCH to carry the DCI during an initial access may be replaced with “only AL1”. The preferred (or proposed) AL for a particular scenario may be determined by measuring and reporting, by the UE, during the initial access procedure. By determining a preferred (or proposed) AL, or subset of two or more ALs, it may be possible to reduce the amount of blind detection.

Initial Access with Reduced PDCCH Blind Detection

An initial access procedure is a procedure followed by a device (e.g. UE) and a network or network component (e.g. a base station) when the device initially accesses the network, either for the first time or after a period of inactivity by the device. Examples of initial access procedures include 4-step random access channel (RACH) procedure, may include the following messages.
Step 1: Preamble Transmission (Message 1) (UE→BS) The system may configure multiple random access opportunities or occasions for UEs to perform initial access to the network. One random access occasion may include random access time-frequency resources (i.e., random access channel), preamble sets used for a UE to choose a preamble from for the random access, etc. A UE may first select a preamble from a set of preambles in a random access occasion and send the preamble to a base station (BS) or network.
Step 2: Random Access Response (Message 2) (BS→UE) To respond to the reception of Message 1 and allocate UL transmission resources for sending Message 3, the BS may send a random access response (RAR) message to the UE in a DL data channel. The UE has to monitor a PDCCH that carries the scheduling information (i.e., DCI) to decode and get the time and frequency resources of the DL data channel. Put another way, the UE may monitor a PDCCH that carries scheduling information (e.g., DCI) to receive Message 2 or RAR message. Therefore, generally speaking, Message 2 or the RAR message may be received in a transmission resource associated with the scheduling information received over the control channel (e.g., PDCCH) after sending Message 1. The PDCCH may be one of multiple PDCCH candidates that are configured for initial random access processes to the BS and, as a result, the UE has to perform blind detection on each of the multiple PDCCH candidates as described above (e.g., 12 PDCCH candidates with AL4, AL8 and AL16 in NR, each AL with 4 PDCCH candidates). After decoding the DCI, the UE is able to receive and decode Message 2, or RAR message, in the DL data channel.
Step 3: Scheduled Data Transmission (Message 3) (UE→BS) The time and frequency resources, as well as other parameters such as timing advance information, for sending Message 3 may be found in the RAR message (i.e., Message 2) in the DL data channel. Then the UE may send Message 3 based on the allocated time-frequency resources and the other parameters for UL data transmission, where the UE may provide a UE identity for a contention resolution.
Step 4: Contention Resolution Message (Message 4) (BS→UE) The BS may send a contention resolution message in a DL data channel to the UE to finish the initial access procedure. The contention resolution at the BS is done based on information comprising the UE identity that is received in Message 3 from the UE. To receive the contention message, the UE again has to detect a PDCCH by trying to decode multiple PDCCH candidates to obtain the scheduling information/DCI, which includes the time-frequency resources for the DL data channel. Therefore, generally speaking, the contention resolution message may be received in a transmission resource associated with the scheduling information received over the control channel (e.g., PDCCH) after sending Message 3. Thus, the information regarding channel quality (e.g., quality of the signal used for communication between the apparatus and the device) or appropriate resources for DL control information that may be reported or fed back from the UE prior to transmission of Message 4 may be useful to reduce a number of blind detections on a PDCCH that may carry a scheduling signaling (i.e., DCI) for receiving Message 4.

In the process described above, the UE has to perform a blind detection at least two times during the initial access procedure in order to determine the correct PDCCH from multiple PDCCH candidates. In the initial access to a network, the PDCCH candidates may be configured using system information, such as a master information block (MIB), a synchronization signal block (SSB) and/or a system information block (SIB1 or SIB2).

Another example of initial access procedures is a 2-step RACH procedure. In this procedure, the UE send a single message (Message A) to the BS that includes both a preamble transmission (similar to Message 1 in 4-step RACH) and a scheduled data transmission (similar to Message 3 in 4-step RACH). Similarly, the BS sends a single message (Message B) to the UE including both a random access response (RAR) message (similar to Message 2 in 4-step RACH) and a contention resolution message (similar to Message 4 in 4-step RACH). The UE may receive Message B in a transmission resource associated with the scheduling information received over the control channel (e.g., PDCCH).

An SSB is the first signal a UE may detect to get DL synchronization during an initial access to a base station (cell) and very basic system information (MIB, main information bits) for the UE to go ahead to receive more information from the network.

As the BS has no information about the downlink (DL) channel condition or the UE location, it may need to transmit a DCI with a very conservative aggregation level. In a new radio (NR) network, the system configures PDCCH candidates with an aggregation level of at least AL4 in a cell-based common search space (CSS). Thus, the PDCCH candidates for random access exclude those with levels AL1 and AL2, and the blind detection at a UE end is performed among the PDCCH candidates with levels AL4, AL8 and AL16.

If a UE is located close to a BS upon initial access to the BS, a PDCCH with AL2 or even AL1 may be able to carry the DCI to the UE with sufficient reliability. Thus, excluding AL1 and AL2 may not be necessary in random access procedures. The appropriateness of an AL may be based on the information on the channel condition and the UEs distance to the BS. In some examples in this application, the PDCCH candidates may include AL1 and AL2, which is applicable to a UE that has good channel conditions or is close to an accessing BS. A good channel condition may have a channel condition parameter that is equal to or greater than a particular threshold value. A channel condition or a distance to the BS may be measured by the UE when performing initial access to the network based on DL reference signals, e.g., SSBs, from one or more base stations. Usually, the channel measurement at a reception end uses information such as a known transmission power and a known reference signal from the transmission end.

A UL measurement in the UE preamble signal(s) received by the BS may not be reliable in the sense that a UL transmission power (level) from the UE may not be certain or may not be fixed. For example, the UL transmission power may be adaptive to the channel during an initial access procedure in the sense that it may raise from an initial UL transmission power by a power offset if the UE doesn't get a response from the BS within a certain period of time. Thus, the UL transmission power may be uncertain to the BS. A DL measurement on a DL reference signal by the UE, however, may be more reliable and/or accurate as the information on transmission power of the BS is available or known to the UE by pre-definition or by configuration in the system information. Moreover, the DL measurement by the UE may be used to evaluate the channel conditions and the distance to the BS to help determine which PDCCH(s) may carry a DCI to the UE in a reliable way based on the type(s) of ALs (or a subset of ALs), from a configured set of ALs.

The channel measurement(s) on DL reference signal(s) transmitted by a UE may allow for a more accurate decision of aggregation levels that may be used for a PDCCH to reliably carry the scheduling information or DCI. As a result, the ALs of a PDCCH used in a transmission may not be limited to AL4, AL8 and AL16 as currently adopted in NR, and any aggregation level from AL1, AL2, up to AL16 (or any other AL) may be used, depending on, for example, a channel measurement and/or report by the UE. In some implementations, the channel measurement may be based on a metric including at least one of reference signal received power (RSPR), reference signal received quality (RSRQ), or signal to interference-plus-noise ratio (SINR).

RSRP stands for Reference Signal Received Power. It is the average power received from a single Reference signal and its typical range is around −44 dbm (good) to −140 dbm (bad). RSRQ stands for Reference Signal Received Quality. It indicates the quality of the received signal and its range is typically around −19.5 dB (bad) to −3 dB (good). SINR stands for Signal-to-Interference-plus-Noise Ratio. It is the signal-to-noise ratio of the given signal.

When a UE is performing an initial access to a network, the UE may need to search and synchronize with one or more base stations based on one or more SSBs from each base station. The UE may determine the channel conditions and quality based at least on measurements from the one or more SSBs received from that base station. For example, the measurement metrics in an SSB may include at least measurement information such as SSB RSRP (reference signal received power), SSB RSRQ (reference signal received quality), SSB SINR (signal to interference-plus-noise ratio), etc. In other words, the UE may determine the channel conditions and quality based at least one of SSB RSRP, SSB RSRQ, or SSB SINR.

The DL measurement metrics used by a UE include the channel condition and/or the UE to BS distance indication that may be used to limit the number of PDCCH candidates, as discussed above. For example, a typical range of (average) RSRP may be, e.g., −40 dbm to −140 dbm, where −40 dbm may be an indication of an excellent channel condition, in which a PDCCH with AL1 may be able to reliably deliver a transmission of a DCI to the UE, and −140 dbm may be an indication of a poor channel condition, in which a PDCCH with AL16 may be used to reliably deliver a transmission of a DCI to the UE. An RSRQ indicates the quality of the received signal with its range being, e.g., −20 dB to 0 dB, where 0 dB is an indication of an excellent channel condition, in which a PDCCH with AL1 may be able to reliably deliver a transmission of a DCI to the UE, and −20 dB is an indication of a poor channel condition, in which a PDCCH with AL16 may be used to reliably deliver a transmission of a DCI to the UE. As a result, a set of categorized measured channel conditions based on one or more of the measurement metrics may be associated with different groups of ALs that may be used in a PDCCH to deliver a DL control information (DCI) with a desired reliability, where each group may comprise one or more ALs. The measurement metrics may include at least one of RSPR, RSRQ, SINR, SSB RSRP, SSB RSRQ, or SSB SINR.

A tabulated configuration of the above may comprise a set of categorized measured channel conditions based on one or more of the measurement metrics, where one categorized channel condition (or a channel condition range) corresponds to a group of one or more Als, and one measurement metric may comprise at least one of RSRP, RSRQ or SINR. The measurement metric may also comprise at least one of SSB RSRP, SSB RSRQ, or SSB SINR.

FIG. 6 illustrates an example mapping between a channel measurement, or an index value associated with the channel measurement, and a group of AL(s) for PDCCH transmission, or an index value associated with the group of AL(s).

In an example shown in FIG. 6, RSRP values are categorized into K groups, where the categorization k of RSRP is configured with a range of value: RSRPₖₒ˜RSRPₖ₁, k=0, 1, . . . , K−1, and a measured RSRP may belong to one of the K categorized groups. More generally, K may be an integer greater than 1. An example of how each RSRP value may be indexed is described in a metric table 610 (e.g., each RSRP range is associated with one of the categorized indices 0 to K−1, as shown in the metric table 610). The aggregation levels AL1, AL2, AL4, AL8 and AL16 are categorized into five AL groups, where one group may comprise at least one AL. In other words, {AL x} may indicate that the AL group to which {AL x} belongs include at least AL x, where “x” indicates the aggregation level, e.g., 1, 2, 4, 8, or 16. For example, {AL1} belonging to AL group o may comprise AL1 and optionally, AL 2 and/or other ALs; {AL2} belonging to AL group 1 may comprise AL2 and optionally, AL 3 and/or other ALs; . . . ; {AL16} belonging to AL group 4 may comprise AL16 and optionally, AL 8 and/or other ALs. An example of how each AL group may be indexed is described in an AL table 620 (e.g., each AL group is associated with an AL group index, as shown in the AL table 620). An element from one table (e.g., metric table) may map to an element of the other table (e.g., AL table) according to one of the following relationships: one-to-one mapping, multiple-to-one mapping, one-to-multiple mapping, and multiple-to-multiple mapping. The metric table and the AL table may be the metric table 610 and the AL table 620, respectively. The mapping relationship may be expressed in terms of element indexing, for example, categorized index 0 or 1 may be mapped to AL group index 0 (in such a case, it is multiple-to-1 mapping). It may be noted that in the present disclosure, map, mapping, or mapping relationship may be interchangeably used with associate, association, association relationship, or other similar expressions. For example, a mapping between a first element from a metric table and a second element from an AL table may be also understood as an association between a first element from a metric table and a second element from an AL table. In another example, a one-to-one mapping may be also understood as a one-to-one association.

Each categorized or grouped table may be pre-defined or pre-configured and a mapping relationship between one element with a categorized index in a metric table and an element with an AL group index in an AL group table may be pre-defined, pre-configured and/or configured by broadcast (e.g., system information, SSB, etc.), cell common signaling or UE specific signaling (e.g., RRC). Using these two tables and associated mapping, the UE may make a recommendation or request to a base station based on the DL channel measurement, for a group of AL(s) that are configured for one or more PDCCH candidates in a search space, among which one PDCCH may be selected from and used for transmitting a DCI.

During an initial access to a network, a UE may perform a random access procedure and the first UL transmission from the UE to the base station may comprise a preamble transmission, where a preamble included in the transmission is chosen from a set of preambles that are configured for random-access procedures in the base station. To allow for faster notifications or feedback to the base station about the DL channel condition or quality, a subset of the set of preambles (or a preamble group) may be used to indicate a certain level of channel condition or quality, and multiple sub-sets of the set of preambles may be used to indicate different levels of channel conditions or quality.

Note that one network may have multiple base stations and one base station may have its own set of preambles, which may be different from preambles for neighboring base stations. The preambles in a preamble set have to be orthogonal in terms of sequence correlation or cross-correlation properties to avoid or reduce mutual interference.

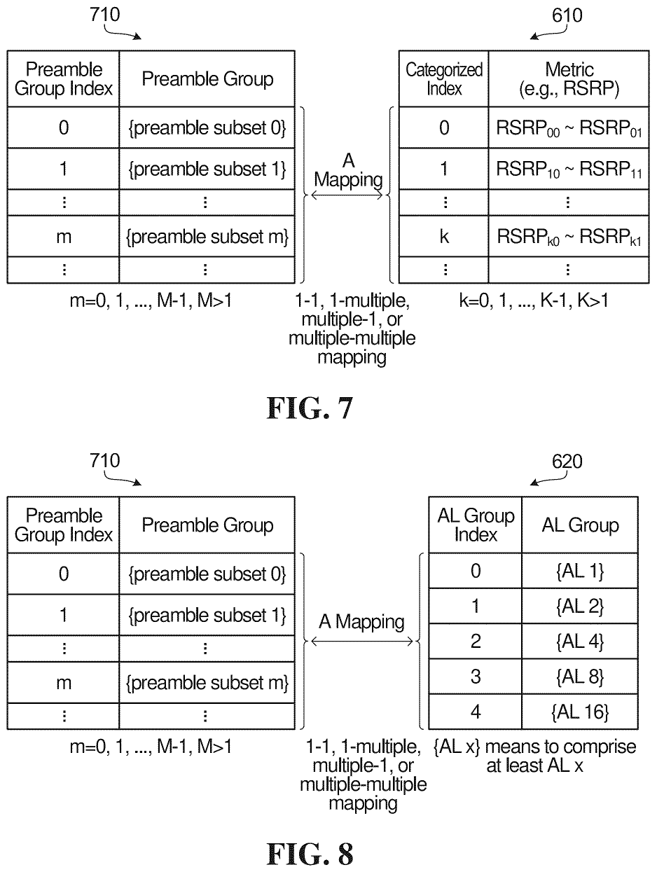

For example, a set of preambles that are configured for random-access procedures in the base station may be divided (grouped) into two or more subsets, each subset comprising one or more preambles, and each of the subsets of preamble(s) may be associated with or mapped to a categorized index of a measurement metric (e.g., RSRP). The mapping may be one of the following: one-to-one mapping, multiple-to-one mapping, one-to-multiple mapping, and multiple-to-multiple mapping. The mapping relationship may be expressed in terms of element indexing, for example, preamble group index 0 may be mapped to categorized index 0 or 1 in a measurement metric (in such a case, it is 1-to-multiple mapping). An exemplary mapping is shown in FIG. 7, where the number of preamble subsets is M>1 and the number of categorizations of a metric is K>1, where the positive integer numbers M and K may or may not be the same. M may be an integer greater than 1.

FIG. 7 illustrates an exemplary mapping between a preamble group (or a preamble subset) and a channel measurement range (M and K may or may not be the same). In FIG. 7, a set of preambles that may be configured for random-access procedures are divided into M groups, as shown in the preamble group table 710. More generally, M may be an integer greater than 1. Each preamble group may be indexed as shown in the preamble group table 710 (e.g., each preamble group may be associated with one of the preamble group indices 0 to M−1, as shown in the preamble group table 710). Each of the preamble groups may be all or a subset of preambles that may be used for establishing the connection between the apparatus (e.g., UE) and the device (e.g., base station). For example, the preamble group with a preamble group index 0 may correspond to {preamble subset 0} that may comprise all or a certain subset of preambles that may be used for establishing the connection between the apparatus and the device, the preamble group with a preamble group index 1 may correspond to {preamble subset 1} that may comprise all or a certain subset of preambles that may be used for establishing the connection between the apparatus and the device, and the preamble group with a preamble group index m may correspond to {preamble subset m} that may comprise all or a certain subset of preambles that may be used for establishing the connection between the apparatus and the device, where m is an integer between 0 and M−1.

An element from the preamble group table 710 may map to an element of a categorized channel measurement metric table (e.g., metric table 610) according to one of the following relationships: one-to-one mapping, multiple-to-one mapping, one-to-multiple mapping, and multiple-to-multiple mapping. The metric table 610 shown in FIG. 7 is same as the metric table 610 described above and in FIG. 6. It is noted that another channel measurement metric table that is different from the metric table 610 may be mapped to the preamble group table 710 in a similar manner.

One of the advantages of using a mapping scheme such as those shown in FIG. 6 and FIG. 7 is that a UE may communicate with a base station about the DL channel conditions or quality such that there is a smaller number of PDCCH candidates, for example with AL4, AL8 or AL16, configured for a group of UEs (in NR). This may reduce the amount of blind detection used by a UE. For example, with the predefined tables and mappings shown in FIG. 6 and FIG. 7, the UE may indicate a channel condition or quality level to a base station, which may correspond to one AL or a limited number of ALs that may be used for associated PDCCH candidates. As a result, the UE may only need to try to detect PDCCH candidate(s) with AL(s) that are implicitly or explicitly indicated by the UE preamble transmission or/and by channel state information (CSI) reporting based on the DL measurement on RS(s), for example, via 4-step RACH or 2-step RACH procedures, where the CSI reporting may include the measurement metrics, including at least measurement information such as SSB RSRP (reference signal received power), SSB RSRQ (reference signal received quality), SSB SINR (signal to interference-plus-noise ratio), etc. The CSI reporting may instead or additionally include measurement information such as RSRP, RSRQ, and/or SINR.

Additionally, PDCCH candidates with AL1 or AL2 may be used during initial access to network instead of a higher minimum AL. According to the current scheme for initial access, the network has to transmit a PDCCH with AL4, AL8 or AL16, which may be not necessary in a method proposed in the present disclosure, if the channel condition is good enough or the UE is very close to the BS. In this case, it is proposed to also use AL1 and AL2 (resources) to transmit a PDCCH during a UE initial access to network with one or more UE measurement indications to the BS. Here, “this case” refers to the present disclosure. This may use less time-frequency resources to transmit a PDCCH and reduce the amount of blind detection used to determine the PDCCH (e.g., UE indicates to BS to use AL1 and the BS may determine to use it).

### Implicit Indication of Applicable AL(s)

A UE may use grouped preambles, UL data transmission, or a combination of thereof to indicate the channel conditions or quality to a base station, and achieve a consensus between the UE and the base station in an implicit way regarding which ALs to use for a PDCCH transmission based, for example, on the mappings shown in FIG. 6 and/or FIG. 7.

For example, in FIG. 7, a preamble associated with a categorized index of a measurement metric (e.g., RSRP) is selected from a subset of preambles. The subset of preambles may be one of {preamble subset 0}, {preamble subset 1}, . . . , {preamble subset m} included in the preamble group table 710. Each preamble subset in the preamble group table 710 may be associated with at least one of the elements in the channel measurement metric table 610 shown in FIGS. 6 and 7. For the purpose of illustration, it is assumed here that the preamble subset to which the selected preamble belongs is associated with one categorized index of the channel measurement metric table 610. The categorized index of the measurement metric in turn corresponds to an element with an AL group index in the AL group table in FIG. 6. For the purpose of illustration, it is assumed here that the categorized index associated with the preamble subset to which the selected preamble belongs is associated with one AL group index of the AL group table 620 in FIG. 6. Thus, based on configurations on FIG. 7, the UE may transmit a preamble from a preamble group that corresponds to a categorized index in the metric (e.g., one RSRP level) based on its channel measurement; this may imply to indicate on an AL group index (i.e., AL(s) in the element) in FIG. 6 that may be used for transmitting PDCCH by a base station. Specifically, in an example with particular values, a preamble may be selected from {preamble subset m} in the preamble group table 710. The preamble group index m may be associated with the categorized index k that corresponds to the RSRP range of RSRPₖ₀˜RSRPₖ₁. The categorized index k of the channel measurement metric table 610 may be associated with the AL group index 1 that is associated with the AL group {AL 2}. Accordingly, the preamble selected from the {preamble subset m} may implicitly indicate that the AL group {AL 2} may be used for transmission of scheduling information (e.g., DCI) over the PDCCH. It is noted that the selected preamble may be transmitted from the apparatus (e.g., UE) to the device (e.g., base station) via Message 1 (in 4-step RACH procedure) or Message A (in 2-step RACH procedure).

As another example, the UE may use a UL data transmission sent to a base station to indicate a categorized index of a measurement metric (e.g., RSRP), as shown in FIG. 6, where selection of the categorized index is based on the actual channel condition or quality that is measured from a DL reference signal, such as an SSB. For example, the UL data transmission may include transmission of information indicative of quality of a DL reference signal (DL RS). The quality of the DL RS may be based on, for example, SSB RSRP, SSB RSRQ, and/or SSB SINR. The UE may identify one of the categorized indices 0 to K−1 in the metric table 610 that corresponds to the measured quality of the DL RS. The UE may transmit, to the base station, the categorized index or information indictive thereof using Message 3 (in 4-step RACH procedure) or Message A (in 2-step RACH procedure).

Alternatively, the UE may use a UL data transmission to directly report CSI reporting data with actual metric value (i.e., the actual measurements on a DL reference signal) without reference to mappings such as those shown in FIG. 6 or FIG. 7. In some embodiments, the UE may transmit any information indicative of quality of the DL RS, or a CSI report which may include at least one of RSRP, RSRQ, SINR, SSB RSRP, SSB RSRQ, or SSB SINR. In this alternative scheme, a UL data channel for the UL data transmission (to indicate or send CSI reporting) during an initial access process may be, for example, MsgA for 2-stept RACH or Message 3 for 4-step RACH. MsgA may be also referred to as Message A. After the UL transmission, the base station may identify one of the categorized indices 0 to K−1 in the metric table 610 that corresponds to the received information indicative of quality of the DL RS. The details may be provided in the following embodiments. Note that in such a scenario, there is no need to play with the preamble indication of the channel conditions or quality, which means that a legacy preamble transmission may be performed in the initial access to network.

A UE may use grouped preambles or a UL data transmission to indicate the channel conditions or quality to a base station, as described above, in order to achieve a consensus between the UE and the base station, in an implicit way, regarding which ALs to use for PDCCH transmission based on, for example, FIG. 6 and/or FIG. 7. Another option would be to combine the two indication schemes, i.e., use both the grouped preambles and UL data transmission to notify the base station on the channel conditions or quality. This may reduce the amount of blind detection used by a UE.

During an initial access to network, a UE may send an indication of aggregation level(s) that may be applicable to PDCCH candidates to a BS and expect the BS to use the indicated AL(s) in a PDCCH to carry a DCI. Such a scheme may reduce the blind detection used by a UE to find the PDCCH that carries a DCI. There are multiple ways of indicating ALs or AL associated information to the BS, including the following. The indicating ALs or AL associated information to the BS may refer to the explicit indication of applicable AL(s) and is described below with reference to FIG. 8. FIG. 8 illustrates an example mapping between a preamble group (or a preamble subset) or an index value associated with the preamble group and a group of AL(s) for PDCCH transmission or an index value associated with the group of AL(s).
Preamble indication on AL(s): a set of preambles configured for a random-access occasion in a base station may be divided (grouped) into two or more subsets, each subset comprising one or more preambles, and a subset of preamble(s) may be associated with or mapped to a categorized index of a measurement metric (e.g., RSRP) such as in FIG. 7. For direct indication on AL(s), a subset of preamble(s) may be associated or mapped to a group of AL(s), and used to populate tables, such as those shown in FIG. 8, where the mapping in the tables may be one of the following: one-to-one mapping, multiple-to-one mapping, one-to-multiple mapping, and multiple-to-multiple mapping. The mapping relationship may be expressed in terms of indexing, for example, an index on a subset of preambles may be mapped to an AL group index.
For example, a UE may select a preamble from a subset of preambles based on measurements from an SSB (e.g., channel conditions and quality), and then send the preamble to a BS. The BS may determine the AL(s) indicated by the preamble based on a mapping such as the mapping shown in FIG. 8, which also indicate the channel conditions and quality observed by the UE. As a result, the BS may use a PDCCH with one of the indicated AL(s) as the PDCCH used to carry a DCI to the UE. The UE is expecting one or more PDCCHs that use the AL(s) indicated by the UE to the BS. In this way, the UE may reduce the amount of blind detection used as PDCCH candidates with the other ALs (i.e., ALs not explicitly indicated by the preamble) need not be considered. For example, based on UE channel measurement on SSB, the channel is perfect, so the UE may use a preamble in preamble subset o to indicate a BS that AL 1 may be used, when the preamble is received by the BS, the BS knows that the preamble is from the preamble subset o based on configuration of FIG. 8, so the BS may determine to use AL1 to transmit PDCCH (which is the UE has indicated using the preamble and is expected to detect PDCCH with AL1(allocation).

Put another way, in an example using particular values in the preamble group table 710 and the AL group table 620 shown in FIG. 8, the UE may select a preamble to use from the preamble group {preamble subset 0}. The preamble group table 710 and the AL group table 620 in FIG. 8 may be the same as those described above and in FIGS. 6 and 7. The preamble group {preamble subset 0} may correspond to the categorized index 0 that corresponds to the RSRP range of RSRP₀₀˜RSRP₀₁ in which the RSRP measured on the DL RS is included. The selected preamble may be transmitted from the UE to the base station via Message 1 (in 4-step RACH procedure) or Message A (in 2-step RACH procedure). The base station may identify the AL group index 1 based on the received preamble, the preamble group table 710, the AL group table 620, and/or the mapping between the preamble group table 710 and the AL group table 620. Then, the base station may use one of the candidate PDCCHs with {AL 1} corresponding to the AL group index 1 (i.e., AL groups that comprises at least AL1) to transmit scheduling information (e.g., DCI) to the UE. For the purpose of illustration, it is here assumed that the {AL 1} comprises only AL 1. The UE may monitor only PDCCH candidates having AL 1.
UL data indication on ALs: Instead of using a preamble to indicate the intended AL(s) as described above, an AL group index may be sent via a UL data channel during the initial access to a base station, e.g., using MsgA in 2-step RACH or Message 3 in 4-step RACH. MsgA may refer to Message A. More details are provided below. Such a scheme may reduce the amount of blind detection used by the UE to determine the PDCCH that carries a DCI.

A mapping between components of the tables in FIG. 6, 7, or 8 may be predefined, preconfigured or configured semi-statically, e.g., RRC, MAC-CE (Medium Access Control-Control Element). More generally, configuration information used for determining the information indicative of the AL group (e.g., mapping between the elements in tables 610, 620, and 710) may be predetermined or received via system information or an RRC signaling. A mapping may be indexed, where a mapping index may be indicated dynamically, e.g., DCI.

### CSI Reporting or AL Indication in 4-Step RACH

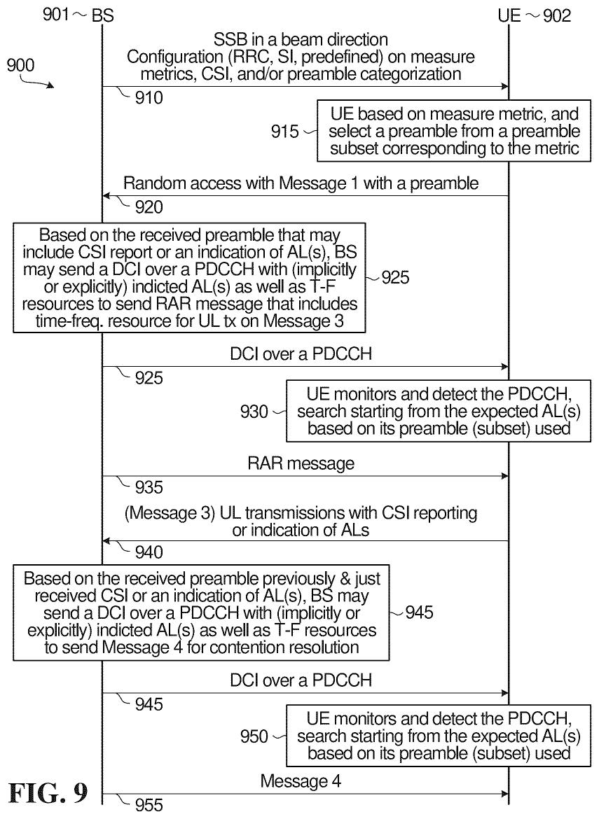

FIG. 9 illustrates an example of a signal flow diagram for 4-step RACH with CSI report and/or an indication of AL(s) between a base station 901 and a UE 902.

In the example 900 shown in FIG. 9, a CSI report and/or an indication of AL(s) may be provided by the UE 902 in Message 1 and/or Message 3 during an initial access using a 4-step RACH. In such a case, the BS 901 may select a PDCCH with a proper AL, where the proper AL may be derived from CSI reporting (i.e., in an implicit way) or obtained from an indication of AL(s) (i.e., in an explicit way) in Message 1 or/and Message 3.

The BS 901 may transmit 910 an SSB in a beam direction (where the transmission signal is sent in a direction with narrow beam width) with system information that includes a configuration of a categorized measurement metric, preamble subsets or/and AL groups, and mapping relationships, e.g., parameter configurations shown in FIG. 6, 7, or 8. These configurations may be system information, RRC or pre-defined. The transmission of an SSB is shown in FIG. 9 as step 910.

In one example, a UE 902 may select 915 a preamble from a preamble subset corresponding to the measured channel conditions or quality (such as RSRP, CQI/channel quality indicator), which is measured over a DL reference signal(s), such as an SSB. The selection of a preamble by the UE 902 is shown in FIG. 9 as step 915.

A UE 902 may perform 920 a random access with Message 1 using a preamble that may indicate a channel condition level or information on AL(s). The random access with Message 1 using a preamble is shown in FIG. 9 as step 920.

Based on the received preamble that may include a CSI report or an indication of AL(s), a BS 901 may send 925 a DCI over a PDCCH with (implicitly or explicitly) indicted AL(s) as well as send an RAR message (in a DL data channel), later at step 935, that includes UL time-frequency resource for Message 3. The transmission of a DCI over a PDCCH is shown in FIG. 9 as step 925.

The UE 902 may search 930 for the PDCCH starting with PDCCH candidates having the expected AL(s) corresponding to the selected preamble (subset) that was used in Message 1. The PDCCH searching, which may be also considered as monitoring and/or detecting a PDCCH, is shown in FIG. 9 as step 930. The UE 902 may detect the PDCCH that carries the DCI and decode the DCI.

After decoding the DCI, the UE 902 may receive 935, from the BS 901, a RAR message in the DL data channel, for example, based on scheduling information included in the DCI. The transmission of the RAR message is shown in FIG. 9 as step 935. The UE 902 may decode the RAR message in the DL data channel, and obtain its UL time-frequency resource for transmission of Message 3.

Upon transmission of Message 3, the UE 902 may (optionally) send 940 a CSI reporting or an indication of ALs to the BS 901. The transmission of the CSI reporting or an indication of ALs is shown in FIG. 9 as optional step 940.

Based on the received information in the preamble and/or Message 3 that may include a CSI report or an indication of AL(s), a BS 901 may send 945 a DCI over a PDCCH with (implicitly or explicitly) indicted AL(s) as well as time-frequency resources to send Message 4 (in a DL data channel) for contention resolution. This transmission of a DCI over a PDCCH is shown in FIG. 9 as step 945.

The UE 902 may use the sent information to limit the number of PDCCH candidates to those using the indicated ALs for sending and receiving subsequent messages, e.g., a Message 4. Specifically, the UE 902 may search 950 for the PDCCH starting with PDCCH candidates having the expected AL(s) corresponding to the selected preamble (subset) that was used in Message 1. This PDCCH searching, which may be also considered as monitoring and/or detecting a PDCCH, is shown in FIG. 9 as step 950. The UE 902 may detect the PDCCH that carries the DCI and decode the DCI.

Receiving a Message 4 may also involve PDCCH monitoring and detection by the UE 902. As noted above, the PDCCH monitoring and detection by the UE 902 is shown as step 950 in FIG. 9. A PDCCH may use an AL that may have been derived from CSI reporting or obtained from an indication of AL(s) in Message 1 or/and Message 3. The UE 902 may reduce the detection efforts in determining a PDCCH for scheduling transmission of Message 4 in the same way as it did when receiving a PDCCH for scheduling transmission of Message 2.

After detecting the PDCCH that carries DCI, the UE 902 may receive 955, from the BS 901, Message 4 in the DL data channel, for example, based on scheduling information included in the DCI. The transmission by the BS 901 and reception at the UE 902 of Message 4 are shown in FIG. 9 as step 955.

### CSI Reporting or AL Indication in 2-Step RACH

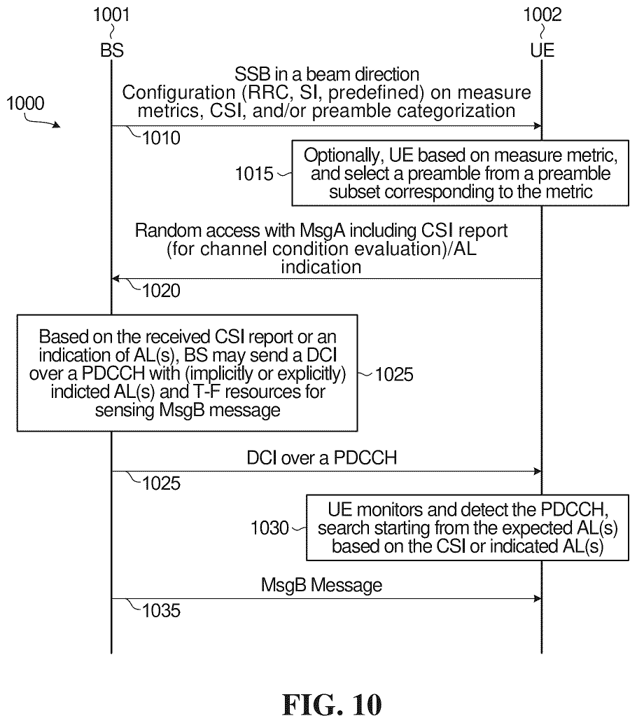

FIG. 10 illustrates an example of a signal flow diagram for 2-step RACH with CSI report and/or an indication of AL(s) between a base station 1001 and a UE 1002.

In the example 1000 shown in FIG. 10, a CSI report and/or an indication of AL(s) may be provided by the UE 1002, in a MsgA, during an initial access using a 2-step RACH. MsgA refers to Message A in a 2-step RACH procedure. The MsgA, transmitted by the UE 1002, includes a preamble and UL data (in a UL data channel). In such a case, a CSI report and/or an indication of AL(s) may be sent using the UL data while the preamble transmission is normal preamble usage. As a result, the BS 1001 may use a PDCCH with a proper AL, where the proper AL may be derived from CSI reporting (i.e., in an implicit way) or obtained from an indication of AL(s) (i.e., in an explicit way) in MsgA.

The BS 1001 may transmit an SSB in a beam direction with system information that includes a configuration of a categorized measurement metric, preamble subsets or/and AL groups, and mapping relationships, e.g., parameter configurations shown in FIG. 6, 7, or 8. These configurations may be broadcast (e.g., system information, SSB, etc.), cell common signaling, UE specific signaling (e.g., RRC) or pre-defined. The transmission of an SSB may be included in step 1010 as shown in FIG. 10.

The UE 1002 may select a preamble from a preamble subset corresponding to the measured channel conditions or quality (such as RSRP, CQI/channel quality indicator), which may be measured over a DL reference signal(s). An example of a DL reference signal may be SSB. The selection of a preamble by the UE 1002 is optional and is shown in FIG. 10 as step 1015.

UE 1002 may perform 1020 a random access with MsgA that includes channel measurement results indicating a channel condition level and/or information on AL(s) based on the measured channel condition level. It is noted that a transmission of a preamble and an initial UL data may be referred to as a transmission of MsgA. At least one of the preamble or the initial UL data may indicate or include the information on channel measurement results and/or information on AL(s) based on the measured channel condition level. The channel measurement results may be a CSI report which may include at least one of RSRO, RSRP, SINR, SSB RSRP, SSB RSRQ, or SSB SINR. The random access with MsgA is shown in FIG. 10 as step 1020.

Based on the received CSI report or the indication of AL(s), a BS 1001 may send 1025 a DCI over a PDCCH with (implicitly or explicitly) indicted AL(s) by Msg A, as well as send Msg B (in a DL data channel) that includes parameters for following UL transmission such as time advance/adjustment information, and contention resolution indication. The transmission of a DCI over a PDCCH is shown in FIG. 10 as step 1025.

UE 1002 may monitor and detect 1030 the PDCCH starting with PDCCH candidates having the expected AL(s) that are implicitly or explicitly obtained from Msg A. The PDCCH monitoring and detecting is shown in FIG. 10 as step 1030. The UE 1002 may detect the PDCCH that carries the DCI and decode the DCI.

The UE 1002 may decode the MsgB in the DL data channel. MsgB refers to Message B. The UE 1002 may receive 1035, from the BS 1001, MsgB in the DL data channel, for example, based on scheduling information included in the DCI. The receipt of MsgB, including contention resolution message and other parameters such as timing advance information, is shown in FIG. 10 as step 1035.

### Method for Detecting or Identifying a Control Channel

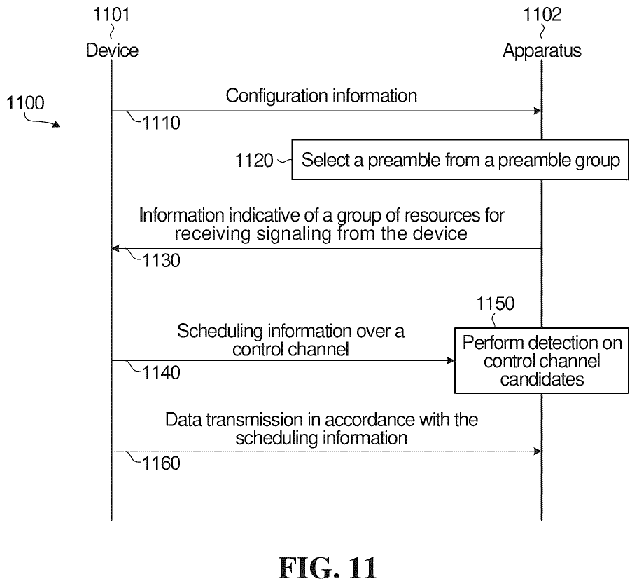

FIG. 11 is a signal flow diagram illustrating an example method for detecting or identifying a control channel used to transmit scheduling information in a wireless network, in accordance with embodiments of the present disclosure.

The example process 1100 is comprised of steps 1110, 1120, 1130, 1140, 1150, and 1160. Some of the steps may be optional. It should be understood that, in some embodiments, the order of one or more steps 1110, 1120, 1130, 1140, 1150, and 1160 may be changed.

At step 1110, a device 1101 may transmit, to an apparatus 1102, configuration information used for determining information indicative of a group of resources that may be (to be) used (by the apparatus 1102) for receiving signaling from the device 1101. In some embodiments, the configuration information may be transmitted from the device 1101 to the apparatus 1102 via system information or a radio resource control (RRC) signaling. In some embodiments, the configuration information may not be transmitted from the device 1101 to the apparatus 1102, but instead may be predetermined or may be a combination of predetermined configuration information and signaled configuration information.

The configuration information may include at least one of information indicative of a first association, information indicative of a second association, or information indicative of a third association. The first, second, and third associations are discussed below.

The first association may be an association between i) the group of resources that may be (to be) used (by the apparatus 1102) for receiving signaling from the device 1101 and ii) quality of a signal used for communication between the apparatus 1102 and the device 1101. In some embodiments, the group of resources may include an aggregation level group for receiving signaling from the device 1101. The aggregation level group may include one or more aggregation levels, and each of the one or more aggregation levels may include one or more control channel elements (CCEs). In some embodiments, the quality of the signal used for communication between the apparatus 1102 and the device 1101 may be determined based on a channel measurement on a downlink (DL) reference signal (DLRS).

The second association may be an association between a preamble group and the quality of the signal used for communication between the apparatus 1102 and the device 1101. The preamble group may be all or a subset of preambles to be used for establishing the connection between the apparatus 1102 and the device 1101. The preamble group may comprise one or more preambles. The one or more preambles in the preamble group may be associated with at least one of i) the quality of the signal used for communication between the apparatus 1102 and the device 1101, or ii) the group of resources that is (to be) used (by the apparatus 1102) for receiving signaling from the device 1101.

The third association may be an association between the group of resources and the preamble group. The group of resources and the preamble group are those discussed above in connection with the first and second associations.

In some embodiments, at least one of the first association, the second association, or the third association may be a one-to-one, one-to-many, many-to-one, or many-to-many association.

In some embodiments, the apparatus 1102 may select, at step 1120, a preamble from the preamble group. The selected preamble may be a preamble that is (to be actually) used to establish connection between the apparatus 1102 and the device 1101. In some embodiments, step 1120 may be performed when i) the apparatus 1102 transmits, at step 1130, information indicative of the group of resources in Message 1, Message 3, or Message A, and ii) the information indicative of the group of resources includes the (selected) preamble.

At step 1130, the apparatus 1102 may transmit, to the device 1101, the information indicative of the group of resources. The group of resources may be indicative of one or more control channel candidates. At least one of the one or more control channel candidates may be (to be) used by the device 1101 to transmit scheduling information for a data transmission between the apparatus 1102 and the device 1101 in the wireless network.

In some embodiments, the information indicative of the group of resources includes at least one of i) the preamble used to establish connection between the apparatus 1102 and the device 1101, ii) the information indicative of the quality of the signal used for communication between the apparatus 1102 and the device 1101, or iii) an indication of the group of resources (that may be used for receiving signaling the device 1101).

In some embodiments, the information indicative of the group of resources may be included in at least one of Message 1, Message 3, or Message A during the initial access.

In some embodiments where the information indicative of the group of resources is included in Message 1, Message 3 or Message A, the information indicative of the group of resources may include the (selected) preamble.

In some embodiments where the information indicative of the group of resources is included in Message 1, Message 3 or Message A, the information indicative of the group of resources may include at least one of i) the information indicative of the quality of the signal used for communication between the apparatus 1102 and the device 1101, or ii) the indication of the group of resources (that may be used for receiving signaling the device 1101). In some embodiments, the information indicative of the quality of the signal used for communication between the apparatus 1102 and the device 1101 may include a channel state information (CSI) report. The CSI report may include at least one of reference signal received power (RSRP), reference signal received quality (RSRQ), signal-to-interference plus noise ratio (SINR), synchronization signal block (SSB) RSRP, SSB RSRQ, or SSB SINR.

At step 1140, the device 1101 may transmit, to the apparatus 1102, the scheduling information over the control channel. The control channel may be one of the one or more control channels of which the group of resources may be indicative. In some embodiments, the control channel may be a physical downlink control channel (PDCCH). In some embodiments, the scheduling information may include downlink control information (DCI).

At step 1150, the apparatus 1102 may perform detection on the one or more control channel candidates to identify the control channel used by the device 1101 to transmit the scheduling information. The detection may be a blind detection.

At step 1160, the apparatus 1102 may receive, from the device 1101, data in a transmission resource associated with the scheduling information received over the control channel. In other words, the data transmission is performed in accordance with the received scheduling information. In some embodiments, the data may include at least one of Message 2, Message 4, or Message B.

Examples of apparatuses and/or devices (e.g., ED or UE and BS or network device) to perform the various methods described herein are also disclosed.

For example, a device may include a memory to store processor-executable instructions, and a processor to execute the processor-executable instructions. When the processor executes the processor-executable instructions, the processor may be caused to perform the method steps of one or more of the apparatuses and/or devices as described herein, e.g., in relation to FIG. 11. For example, the processor may cause the apparatus and/or device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

The present disclosure encompasses various examples, including not only method examples, but also other examples such as apparatus examples and examples related to non-transitory computer readable storage media. Examples may incorporate, individually or in combinations, the features disclosed herein.

Although this disclosure refers to illustrative examples, this is not intended to be construed in a limiting sense. Various modifications and combinations of the illustrative examples, as well as other examples of the disclosure, will be apparent to persons skilled in the art upon reference to the description.

Features disclosed herein in the context of any particular examples may also or instead be implemented in other examples. Method examples, for example, may also or instead be implemented in apparatus, system, and/or computer program products. In addition, although examples are described primarily in the context of methods and apparatus, other implementations are also contemplated, as instructions stored on one or more non-transitory computer-readable media, for example. Such media could store programming or instructions to perform any of various methods consistent with the present disclosure.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terms “coupled”, “coupling” or “connected” as used herein may have several different meanings depending on the context in which these terms are used. For example, as used herein, the terms coupled, coupling, or connected may indicate that two elements or devices are directly connected to one another or connected to one another through one or more intermediate elements or devices via a mechanical element depending on the particular context.

The term “receive”, “detect” and “decode” as used herein may have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. In some scenarios, if an apparatus implementing a method described herein is an integrated circuit, the term “receive” may mean “input” or “obtain”, and the term “transmit” may mean “output.”

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
transmitting information indicative of a group of resources for receiving signaling from a device, the group of resources indicative of one or more control channel candidates, wherein at least one of the one or more control channel candidates is to be used by the device to transmit scheduling information for a data transmission between the apparatus and the device in the wireless network; and
performing detection on the one or more control channel candidates to identify a control channel used by the device to transmit the scheduling information.

2. The method of claim 1, wherein the information indicative of the group of resources includes at least one of:
a preamble used to establish connection between the apparatus and the device;
information indicative of quality of a signal used for communication between the apparatus and the device; or
an indication of the group of resources;
wherein the information indicative of the group of resources is included in at least one message from the apparatus to the device during an initial access procedure.

3. The method of claim 1, wherein the information indicative of the group of resources includes a preamble included in a preamble transmission during an initial access procedure and the preamble is from a preamble group comprising one or more preambles associated with at least one of:
the quality of the signal used for communication between the apparatus and the device; or
the group of resources;
wherein the preamble group is all or a subset of preambles to be used for establishing the connection between the apparatus and the device.

4. The method of claim 1, wherein when the information indicative of the group of resources is included in a scheduled data transmission message during an initial access procedure, the information indicative of the group of resources includes at least one of:
the information indicative of the quality of the signal used for communication between the apparatus and the device; or
the indication of the group of resources.

5. The method of claim 1, further comprising:
receiving configuration information used for determining the information indicative of the group of resources, the configuration information including at least one of:
information indicative of a first association that is an association between the group of resources and quality of a signal used for communication between the apparatus and the device,
information indicative of a second association that is an association between a preamble group and quality of the signal used for communication between the apparatus and the device, or
information indicative of a third association that is an association between the group of resources and the preamble group;
wherein the preamble group is all or a subset of preambles to be used for establishing the connection between the apparatus and the device.

6. The method of claim 1 further comprising:
receiving data in a transmission resource associated with the scheduling information received over the control channel wherein the data includes at least one of a random access response message and a contention resolution message.

7. The method of claim 1, wherein the group of resources include an aggregation level group for receiving signaling from the device, wherein the aggregation level group comprises one or more aggregation levels and each of the one or more aggregation levels comprises one or more control channel elements.

8. A method comprising:
receiving information indicative of a group of resources for transmitting signaling to the apparatus, the group of resources indicative of one or more control channel candidates; and
transmitting, over a control channel, scheduling information for a data transmission between an apparatus and a device in the wireless network, wherein the control channel is one of the one or more control channel candidates.

9. The method of claim 8, wherein the information indicative of the group of resources includes at least one of:
a preamble used to establish connection between the apparatus and the device;
information indicative of quality of a signal used for communication between the apparatus and the device; or
an indication of the group of resources;
wherein the information indicative of the group of resources is included in at least one message from the apparatus to the device during an initial access.

10. The method of claim 8, wherein the information indicative of the group of resources includes a preamble included in the at least one message from the apparatus to the device during the initial access procedure, and the preamble is associated with at least one of:
the quality of the signal used for communication between the apparatus and the device, or
the group of resources.

11. The method of claim 8, wherein when the information indicative of the group of resources is included in a scheduled data transmission message during an initial access procedure, the information indicative of the group of resources includes at least one of:
the information indicative of the quality of the signal used for communication between the apparatus and the device; or
the indication of the group of resources.

12. The method of claim 8, further comprising:
transmitting configuration information used for determining the information indicative of the group of resources, the configuration information including at least one of:
information indicative of a first association that is an association between the group of resources and quality of a signal used for communication between the apparatus and the device,
information indicative of a second association that is an association between a preamble group and quality of the signal used for communication between the apparatus and the device, or
information indicative of a third association that is an association between the group of resources and the preamble group;
wherein the preamble group is all or a subset of preambles to be used for establishing the connection between the apparatus and the device.

13. The method of claim 8, further comprising:
transmitting data in a transmission resource associated with the scheduling information transmitted over the control channel wherein the data includes at least one of a random access response message and a contention resolution message.

14. The method of claim 8, wherein the group of resources include an aggregation level group for transmitting signaling to the apparatus, wherein the aggregation level group comprises one or more aggregation levels and each of the one or more aggregation levels comprises one or more control channel elements.

15. A device in a wireless network comprising:
a processor coupled to a computer-readable medium having stored thereon, computer executable instructions, that when executed cause the device to perform operations, the operations comprising:
receiving information indicative of a group of resources for transmitting signaling to an apparatus, the group of resources indicative of one or more control channel candidates; and
transmitting over a control channel, scheduling information for a data transmission between the apparatus and a device in the wireless network, wherein the control channel is one of the one or more control channel candidates.

16. The device of claim 15, wherein the information indicative of the group of resources includes at least one of:
a preamble used to establish connection between the apparatus and the device;
information indicative of quality of a signal used for communication between the apparatus and the device; or
an indication of the group of resources;
wherein the information indicative of the group of resources is included in at least one message from the apparatus to the device during an initial access.

17. The device of claim 15, wherein the information indicative of the group of resources includes a preamble included in the at least one message from the apparatus to the device during the initial access procedure, and the preamble is associated with at least one of:
the quality of the signal used for communication between the apparatus and the device, or
the group of resources.

18. The device of claim 15, wherein when the information indicative of the group of resources is included in a scheduled data transmission message during an initial access procedure, the information indicative of the group of resources includes at least one of:
the information indicative of the quality of the signal used for communication between the apparatus and the device; or
the indication of the group of resources.

19. The device of claim 15, wherein the operations further comprise:
transmitting configuration information used for determining the information indicative of the group of resources, the configuration information including at least one of:
information indicative of a first association that is an association between the group of resources and quality of a signal used for communication between the apparatus and the device,
information indicative of a second association that is an association between a preamble group and quality of the signal used for communication between the apparatus and the device, or
information indicative of a third association that is an association between the group of resources and the preamble group;
wherein the preamble group is all or a subset of preambles to be used for establishing the connection between the apparatus and the device.

20. The method of claim 15, wherein the group of resources include an aggregation level group for transmitting signaling to the apparatus, wherein the aggregation level group comprises one or more aggregation levels and each of the one or more aggregation levels comprises one or more control channel elements.
